(19) United States
(12) Patent Application Publication
(10) Pub. No.: US 2018/0359375 A1
(43) Pub. Date: Dec. 13, 2018

(54) FILE MANAGEMENT DEVICE, MULTIFUNCTION APPARATUS, FILE MANAGEMENT METHOD, AND NON-TRANSITORY COMPUTER-READABLE MEDIUM STORING PROGRAM

(71) Applicant: SHARP KABUSHIKI KAISHA, Sakai City (JP)

(72) Inventor: KAYOKO SEO, Sakai City (JP)

(21) Appl. No.: 15/995,687

(22) Filed: Jun. 1, 2018

(30) Foreign Application Priority Data
Jun. 7, 2017 (JP) 2017-112758

(51) Int. Cl. H04N 1/00

(52) U.S. Cl. CPC H04N 1/00212; H04N 1/00225; H04N 2201/3288; H04N 2201/0094; H04N 2201/3295; H04N 1/00244

(57) ABSTRACT

The present disclosure includes a file recording unit that records a file in a given area of a storage medium, a download information transmission unit that transmits download information for downloading the file from the storage medium to one, two, or more download-destination users designated by a transmitting user, a download unit that causes the one, two, or more download-destination users who request downloading of the file in accordance with the download information to download the file, and a file deletion unit that deletes the file upon completion of downloading of the file in a case of deletion designation performed by an authorized user.

### BACKGROUND

### 1. Field

The present disclosure relates to a file management device for managing files uploaded to a server, a multifunction apparatus, a file management method, and a non-transitory computer-readable medium storing a program.

### 2. Description of the Related Art

Most multifunction apparatuses have scanning functionality. Document data obtained by using the scanning functionality can be converted into a file, and the file is then stored in a storage device provided inside or outside a multifunction apparatus. Furthermore, a function of notifying, by email (URL notification mail), a given user of a URL for accessing an image data file of a scanned original document, which is called Scan to URL, is known. A user who has received a URL notification mail may display or download an image data file by selecting the URL in the message body of the URL notification mail.

Japanese Unexamined Patent Application Publication No. 2004-86731 (published Mar. 18, 2004) discloses a scan mail transmitting device in which a URL and a password for downloading a file of a scanned original document from a server are sent via email, and only the person who has received the email can download the file.

Japanese Unexamined Patent Application Publication No. 2016-63379 (published Apr. 25, 2016) discloses an information processing device in which the URL of a website for obtaining a file and the URL of a website for deleting the file are sent to an administrator, while only the URL of the website for obtaining the file is sent to destination addresses other than that of the administrator, so that everyone can obtain the file, while only the administrator can delete the file.

Japanese Unexamined Patent Application Publication No. 2009-301329 (published Dec. 24, 2009) discloses a data processing system in which different URLs for downloading the same file are sent by email to respective destination addresses and the file is deleted when all users who have received the URLs have requested acquisition of the file.

Meanwhile, if an uploaded file is of a confidential document, a measure against information leakage is desired.

In the technique disclosed in Japanese Unexamined Patent Application Publication No. 2004-86731, a user merely enters a password when accessing a website. Hence, there is the risk of information leakage if a third party comes to know the URL and the password.

In the technique disclosed in Japanese Unexamined Patent Application Publication No. 2016-63379, once an administrator accesses the URL of a website for deleting a file, the file is deleted regardless of whether the file is obtained by users. Thus, for example, in a case where a file is deleted by accident, the file is desired to be re-uploaded, and users who have not downloaded the file are inconvenienced.

In the technique disclosed in Japanese Unexamined Patent Application Publication No. 2009-301329, when all users have requested acquisition of a file, the file is immediately deleted, and as a result, the file may not be re-downloaded afterwards. Furthermore, since a file may not be deleted until all users have requested acquisition of the file, in a case where some users do not obtain the file for a long time, the file remains in an uploaded state, thereby entailing a high risk of information leakage.

In the present disclosure, it is desirable to provide a file management device, a multifunction apparatus, a file management method, and a non-transitory computer-readable medium storing a program that are efficient, easy to use, and capable of minimizing the risk of information leakage by timely deleting a file on a website when the file is no longer desired.

### SUMMARY

According to an aspect of the disclosure, there is provided a file management device including a file recording unit that records a file in a given area of a storage medium, a download information transmission unit that transmits, to one, two, or more download-destination users designated by a transmitting user, download information for downloading the file from the storage medium to a client device, a download unit that causes the one, two, or more download-destination users who request downloading of the file in accordance with the download information to download the file, and a file deletion unit that deletes the file upon completion of downloading the file in a case of deletion designation performed by an authorized user.

According to another aspect of the disclosure, there is provided a multifunction apparatus including a file management device including a file recording unit that records a file in a given area of a storage medium, a download information transmission unit that transmits, to one, two, or more download-destination users designated by a transmitting user, download information for downloading the file from the storage medium to a client device, a download unit that causes the one, two, or more download-destination users who request downloading of the file in accordance with the download information to download the file, and a file deletion unit that deletes the file upon completion of downloading the file in a case of designation performed by an authorized user.

According to a further aspect of the disclosure, there is provided a file management method that includes recording a file in a given area of a storage medium, transmitting, to one, two, or more download-destination users designated by a transmitting user, download information for downloading the file from the storage medium to a client device, causing the one, two, or more download-destination users who request downloading of the file in accordance with the download information to download the file, and deleting the file upon completion of downloading the file in a case of deletion designation performed by an authorized user.

According to a still further aspect of the disclosure, there is provided a non-transitory computer-readable medium that stores a program causing a computer to function as a file management device including a file recording unit that records a file in a given area of a storage medium, a download information transmission unit that transmits, to one, two, or more download-destination users designated by a transmitting user, download information for downloading the file from the storage medium to a client device, a download unit that causes the one, two, or more download-destination user who requests downloading of the file in accordance with the download information to download the file, and a file deletion unit that deletes the file upon completion of downloading the file in a case of deletion designation performed by an authorized user.

### BRIEF DESCRIPTION OF THE DRAWINGS

FIG. 1 is a functional block diagram of a multifunction apparatus according to a first embodiment of the present disclosure;

FIG. 2 is a conceptual sectional view of the multifunction apparatus according to the first embodiment of the present disclosure;

FIG. 3 is a view of an example of a screen displayed on a display unit of the multifunction apparatus when a file is uploaded in the first embodiment of the present disclosure;

FIGS. 4A to 4C are views of examples of screens that are displayed on a computer having received a URL notification mail in the first embodiment of the present disclosure;

FIG. 5 is a flowchart illustrating a file management operation of the multifunction apparatus according to the first embodiment of the present disclosure;

FIG. 6 is another flowchart illustrating a file management operation of the multifunction apparatus according to the first embodiment of the present disclosure;

FIG. 7 is a further flowchart illustrating a file management operation of the multifunction apparatus according to the first embodiment of the present disclosure;

FIG. 8 is a still further flowchart illustrating a file management operation of the multifunction apparatus according to the first embodiment of the present disclosure;

FIGS. 9A to 9D are explanatory views illustrating information attached to a file to be downloaded according to the first embodiment of the present disclosure; and

FIG. 10 is an explanatory view illustrating a management table for registering a status or the like according to a third embodiment of the present disclosure.

### DESCRIPTION OF THE EMBODIMENTS

Embodiments of the present disclosure will be described in detail below with reference to the drawings.

### First Embodiment

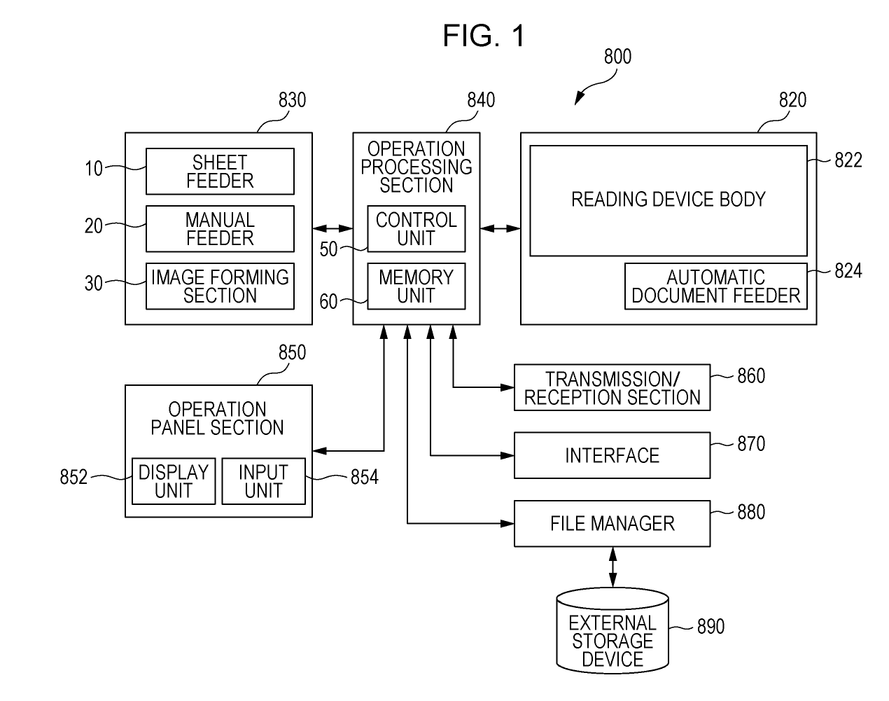

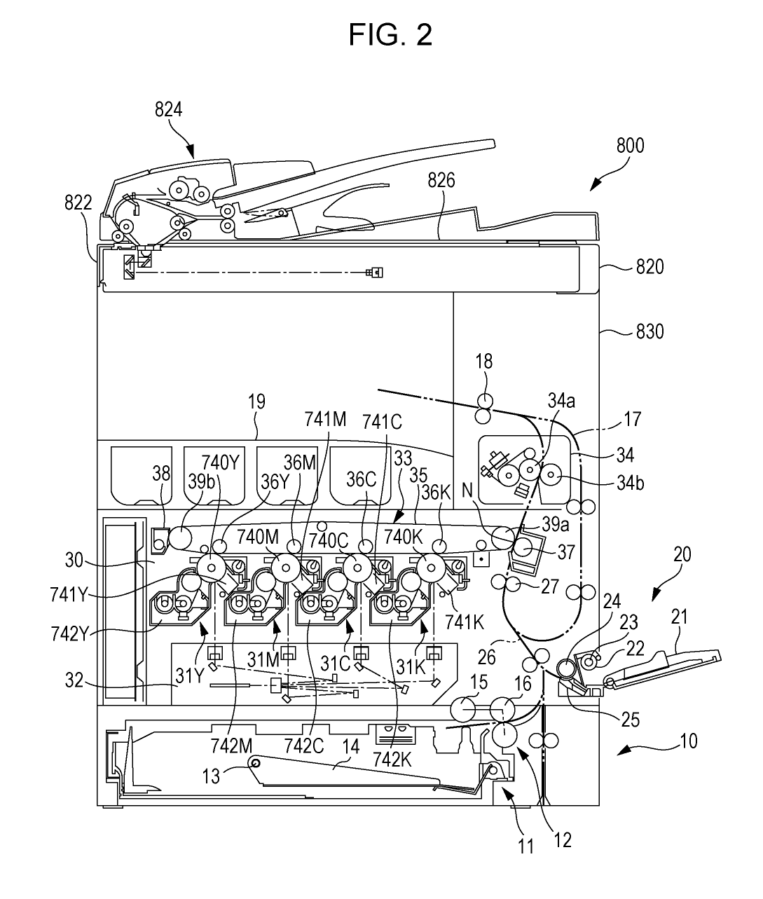

A first embodiment relates to a multifunction apparatus 800 including a document reading device according to the first embodiment and a second embodiment. FIG. 1 and FIG. 2 illustrate a configuration and the like of the multifunction apparatus 800.

As illustrated in FIG. 1 and FIG. 2, the multifunction apparatus 800 includes a document reading device 820 for reading an image of an original document, a multifunction apparatus body (image forming device body) 830 for forming an image on a sheet, an operation panel section 850 for operating the document reading device 820 and the multifunction apparatus body 830, an operation processing section 840 for controlling the document reading device 820 and the multifunction apparatus body 830 in accordance with operations performed via the operation panel section 850, a transmission/reception section 860 for transmitting and receiving image information via various public networks, an interface 870 for communicating with a computer by using a wired or a wireless connection, a file manager 880, and an external storage device 890.

The operation processing section 840 may be connected individually to other components as illustrated in FIG. 1 or may be coupled to other components via a bus.

The operation panel section 850, which is a touch panel display constituted by a display unit 852 and an input unit 854, displays various kinds of information and buttons in accordance with the mode of the multifunction apparatus 800.

The transmission/reception section 860 transmits an image read by the document reading device 820 and an image stored in a storage device and receives an image from outside. The interface 870 is connected to a personal computer via a network. The personal computer connected to the multifunction apparatus 800 can use the functionality of a multifunction apparatus for data managed by the personal computer. The document reading device 820 can individually be used for image reading, and the multifunction apparatus body 830 can individually be used for image forming. In addition, the document reading device 820 and the multifunction apparatus body 830 can cooperate with each other to copy an image.

The document reading device 820 includes an automatic document feeder (single pass feeder (SPF)) 824 for automatically feeding a document and a reading device body 822 for reading an image of a document. The document reading device 820 includes, in addition to the configuration elements illustrated in FIG. 1, configuration elements illustrated in FIG. 2, which are not shown in FIG. 1. As illustrated in FIG. 2, the reading device body 822 is equipped with a document table 826.

The file manager 880 preforms management for writing to and reading from the external storage device 890 an image data file of an original document read by the document reading device 820. The file manager 880 is capable of transmitting an image data file stored in the external storage device 890 to external systems and devices that are connected via the transmission/reception section 860 or the interface 870 in accordance with requests from the external systems and devices. Moreover, the file manager 880 is capable of writing to the external storage device 890 an image data file uploaded from external systems and devices that are connected via the transmission/reception section 860 or the interface 870 in accordance with requests from the external systems and devices. In the present disclosure, “upload” means inputting a file to be written to the external storage device 890, such as an image data file, from inside a multifunction apparatus (for example, the document reading device 820) or outside the multifunction apparatus (for example, external systems and devices connected via the transmission/reception section 860 or the interface 870).

The file manager 880 is implemented as a computer program. The IP address of a server that manages the file manager 880, a folder for storing the computer program, and a URL corresponding to the name of the computer program are assigned to the computer program serving as the file manager 880. Specifying the URL enables access to the file manager 880, and specifying a parameter following the URL enables access to the external storage device 890 under the control of the file manager 880.

The file manager 880 and the external storage device 890 may be included in an external device connected to the multifunction apparatus 800. The external device may be connected to a local or a global IP network.

Furthermore, even in a case where the file manager 880 is included in the multifunction apparatus 800, the file manager 880 may manage a storage device provided outside the multifunction apparatus 800 in the same manner as to manage the external storage device 890. Moreover, the file manager 880 may manage the external storage device 890 in another multifunction apparatus 800 connected to the file manager 880 via a network.

The multifunction apparatus body 830 includes a sheet feeder 10 for feeding a sheet, a manual feeder 20 capable of manually feeding a sheet, and an image forming section 30 for forming an image on a sheet fed by the sheet feeder 10 or the manual feeder 20.

The sheet feeder 10 includes a sheet stacking portion 11 for stacking sheets and a separating and feeding portion 12 for separating and feeding sheets stacked in the sheet stacking portion 11 one by one. The sheet stacking portion 11 includes a middle plate 14 that pivots on an axis shaft 13. The middle plate 14 pivots and lifts up a sheet when feeding the sheet. The separating and feeding portion 12 includes a pickup roller 15 for feeding a sheet lifted up by the middle plate 14, a separation roller pair 16 for separating, one by one, sheets fed by the pickup roller 15.

The manual feeder 20 includes a manual feeding tray 21 for stacking sheets and a separating and feeding portion 22 for separating and feeding, one by one, sheets stacked on the manual feeding tray 21. The manual feeding tray 21 is pivotably supported on the multifunction apparatus body 830, and when sheets are manually fed, the manual feeding tray 21 is fixed at a certain angle to stack the sheets. The separating and feeding portion 22 includes a pickup roller 23 for feeding a sheet stacked on the manual feeding tray 21 and a separation roller 24 and a separation pad 25 for separating, one by one, sheets fed by the pickup roller 23.

The image forming section 30 includes four process cartridges 31Y to 31K for forming respective images of yellow (Y), magenta (M), cyan (9), and black (K), photosensitive drums 740Y to 740K described later, an exposure device 32 for exposing surfaces of the photosensitive drums 740Y to 740K, a transfer portion (transfer unit) 33 for transferring toner images formed on the surfaces of the photosensitive drums 740Y to 740K onto a sheet, and a fixing portion 34 for fixing the transferred toner images on the sheet. Here, alphabet characters “Y”, “M”, “C”, “K” which suffix the reference numerals represent respective colors (yellow, magenta, cyan, and black).

The four process cartridges 31Y to 31K are each formed to be detachable from the multifunction apparatus body 830 and can be replaced. Since the four process cartridges 31Y to 31K have the same configuration other than the color for forming an image, only the configuration of the process cartridge 31Y for forming yellow (Y) image will be described, and description of the process cartridges 31M to 31K is omitted.

The process cartridge 31Y includes the photosensitive drum 740Y serving as an image bearing member, a charger 741Y for charging the photosensitive drum 740Y, a developing device 742Y for developing an electrostatic latent image formed on the photosensitive drum 740Y, and a drum cleaner for removing toner remaining on the surface of the photosensitive drum 740Y. The developing device 742Y includes a developing device body (not shown in detail) for developing an electrostatic latent image formed on the photosensitive drum 740Y and a toner cartridge (not shown in detail) for supplying toner to the developing device body. The toner cartridge is formed to be attachable and detachable to and from the developing device body and can be detached from the developing device body and replaced when stored toner has run out.

The exposure device 32 includes a light source (not shown) that emits a laser beam, mirrors (not shown) for guiding a laser beam onto the photosensitive drums 740Y to 740K, and the like. The transfer portion 33 includes an intermediate transfer belt 35 for bearing a toner image formed on the photosensitive drums 740Y to 740K, primary transfer rollers 36Y to 36K for primarily transferring toner images formed on the photosensitive drums 740Y to 740K onto the intermediate transfer belt 35, a secondary transfer roller 37 for secondarily transferring the toner image transferred onto the intermediate transfer belt 35, a belt cleaner 38 for removing toner remaining on the intermediate transfer belt 35. The intermediate transfer belt 35 is stretched around a drive roller 39a and a driven roller 39b and pressed against the photosensitive drums 740Y to 740K by the primary transfer rollers 36Y to 36K. The secondary transfer roller 37 and the drive roller 39a nip the intermediate transfer belt 35, and a toner image borne by the intermediate transfer belt 35 is transferred onto a sheet at a nip portion N. The fixing portion 34 includes a heating roller 34a for heating a sheet and a pressing roller 34b that is in pressure contact with the heating roller 34a.

The operation panel section 850 includes the display unit 852 for displaying specific information and the input unit 854 via which a user enters an instruction for the document reading device 820 and the multifunction apparatus body 830. In this embodiment, the operation panel section 850 is disposed on the front side of the reading device body 822. The front side corresponds to the front side of the plane of FIG. 2, and the back side corresponds to the back side of the plane of FIG. 2.

As illustrated in FIG. 1, the operation processing section 840 includes a control unit 50 for controlling driving of the sheet feeder 10, the manual feeder 20, the image forming section 30, and the document reading device 820, and a memory unit 60 for storing various programs for operating the control unit 50 and various types of information used by the control unit 50. The memory unit 60 is capable of storing an image read by the document reading device 820 and an image received by the transmission/reception section 860. The operation processing section 840 integrally controls operations of the sheet feeder 10, the manual feeder 20, the image forming section 30, and the document reading device 820 in accordance with a user operation performed on the operation panel section 850, thereby forming an image on a sheet.

Next, an image forming operation performed by the multifunction apparatus 800 (image forming control performed by the operation processing section 840) configured as described above will be explained. In this embodiment, an example is described of an image forming operation in which the automatic document feeder 824 feeds an original document, the reading device body 822 reads an image of the original document, and the image forming section 30 forms the image on a sheet fed by the sheet feeder 10.

When an image-forming starting signal is transmitted upon a user input that is input via the input unit 854 of the operation panel section 850, an original document placed on the automatic document feeder 824 by the user is automatically fed toward a document reading position, and an image of the original document is read at the document reading position by the reading device body 822.

After the image of the original document is read by the reading device body 822, in accordance with the image information of the read original document, the photosensitive drums 740Y to 740K are irradiated by the exposure device 32 with corresponding laser beams. At this time, the photosensitive drums 740Y to 740K are charged in advance by the respective chargers 741Y to 741K.

Electrostatic latent images are formed on the respective photosensitive drums 740Y to 740K by the irradiation with corresponding laser beams. Subsequently, the electrostatic latent images formed on the respective photosensitive drums 740Y to 740K are developed by the developing devices 742Y to 742K, and toner images of yellow (Y), magenta (M), cyan (9), and black (K) are formed on the photosensitive drums 740Y to 740K. The toner images of the respective colors formed on the photosensitive drums 740Y to 740K are superimposed and transferred by the primary transfer rollers 36Y to 36K onto the intermediate transfer belt 35, the superimposed and transferred toner images (forming a full-color toner image) are transported to the nip portion N while being borne by the intermediate transfer belt 35.

In parallel with the image forming operation described above, sheets stacked in the sheet stacking portion 11 are separated one by one by the separating and feeding portion 12 and fed to a sheet transport path 26 by the pickup roller 15. A resist roller pair 27, which is provided upstream of the nip portion N in a sheet transport direction, corrects skew-feed of the sheet and transports the sheet to the nip portion N at a given timing. A full-color toner image borne by the intermediate transfer belt 35 is transferred by the secondary transfer roller 37 onto the sheet transported to the nip portion N.

At the fixing portion 34, by applying heat and pressure to the sheet onto which the toner image is transferred, the toner image is fused and fixed onto the sheet. The sheet is then output to outside the apparatus by an output roller pair 18. The sheet output to outside the apparatus is stacked on an output sheet stacking portion 19.

In a case of forming images on both sides (a first side and a second side) of a sheet, before the sheet on the first side of which an image has been formed is output to outside the apparatus, the sheet is transported to a duplex transport path 17 by reversely rotating the output roller pair 18 and re-transported to the image forming section 30 along the duplex transport path 17. Afterwards, an image is formed on the second side of the sheet in the same manner as for the first side, and the sheet is then output to outside the apparatus. The sheet output to outside the apparatus is stacked on the output sheet stacking portion 19.

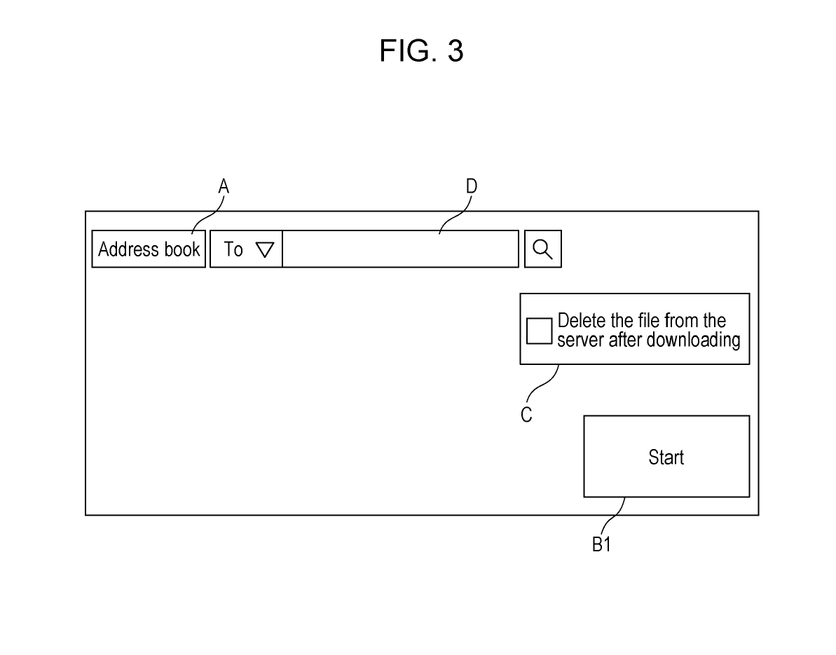

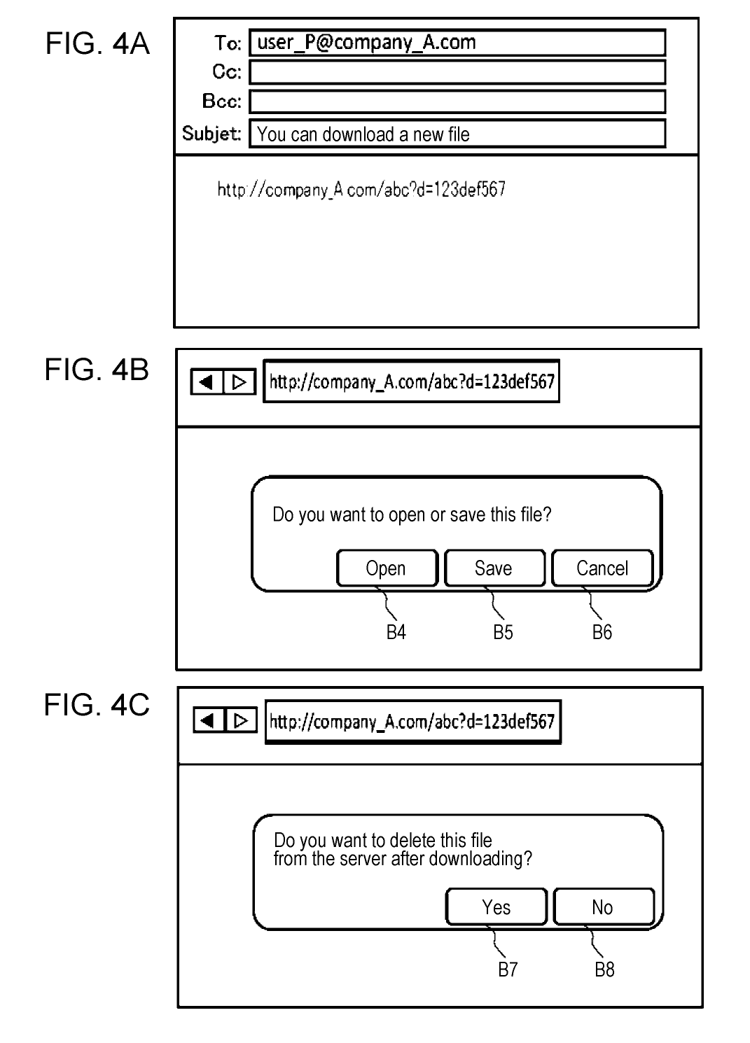

Next, referring to FIG. 3 and FIGS. 4A to 4C, a file management method according to the first embodiment of the present disclosure will be described.

This file management method is based on functionality of accessing a file from outside by specifying the URL corresponding to an uploaded image data file.

For example, in a case where one person preforms, using the operation panel section 850 of the multifunction apparatus 800, an operation for causing the document reading device 820 included in the multifunction apparatus 800 to read an original document and causing the external storage device 890 to record the image data file of the read original document, together with an operation for sending a URL notification mail concerning the image data file of the original document to someone, the one person is the uploader who uploads the image data file to the external storage device 890 and also the sender of the URL notification mail. In this case, the one person performs a designation operation described later, such as designation for deleting a downloaded image data file.

However, for example, in a case where, after one person preforms, by using the operation panel section 850 of the multifunction apparatus 800, an operation for causing the document reading device 820 included in the multifunction apparatus 800 to read an original document and causing the external storage device 890 to record the image data file of the read original document, and another person searches for an image data file of the original document stored in the external storage device 890 and performs an operation for sending a URL notification mail concerning the image data file to someone, the one person is the uploader who uploads the image data file to the external storage device 890 and the other person is the sender of the URL notification mail. In this case, either the one person or the other person performs a designation operation described later, such as designation for deleting a downloaded image data file.

Although the first case of the above-described two cases will be used as an example in the description below, this may be modified for the second case. That is, when it is described, for the sake of convenience, that an uploader here indicating one person performing both operations performs designation, this means that an individual uploader and an individual sender of a URL notification mail both may perform designation. Similarly, when it is described, for the sake of convenience, that a sender of a URL notification mail, the sender here indicating one person performing both operations, performs designation, this means that an individual uploader and an individual sender of a URL notification mail both may perform designation.

In the first embodiment, when the image data file of an original document read by the document reading device 820 is uploaded to the external storage device 890 by the file manager 880, the operations described below can be performed.

An uploader can designate whether to delete an image data file from the external storage device 890 after the file is downloaded. In a case where such designation is performed, an operation according to the designation is performed. In a case of causing two or more persons to download a file, the file is deleted after all the persons have downloaded the file.

In a case where such designation is not performed by the uploader of a file, after a user to whom a URL notification mail is addressed downloaded the file from a website, the file to be deleted can be designated. In a case where a URL notification mail is addressed to multiple destinations, the file is deleted when all destinations have designated the file to be deleted.

FIG. 3 illustrates an example of a screen displayed on the display unit 852 when the document reading device 820 is in a scanner mode. As illustrated in FIG. 3, the screen includes a textbox D for entering a destination address of a URL notification mail, a checkbox C for inputting designation of whether to delete a file after the user of a destination address downloaded the file, and a start button B1 with which a user can start reading an original document, storing the file of the original document in the external storage device 890, and sending an email. In addition, the screen includes an address book button A. A destination address may be directly entered in the textbox D by using a virtual keyboard (not shown), and may be inserted into the textbox D from an address book (not shown), which is displayed by a user pressing the address book button A, by the user selecting the destination address on the displayed address book.

In a case where the checkbox C is checked, after a file is downloaded from a server by the user of a destination address of a URL notification mail, the file on the server is deleted even without designation performed by the user. By contrast, in a case where the checkbox C is unchecked, the user of a destination address of a URL notification mail, after accessing the website and downloading a file, can designate whether to delete the file.

As illustrated in FIG. 4A, a URL notification mail, in which a link text containing the URL of a program for downloading and a parameter for specifying an image data file is shown, is sent to a destination address that has been set on the display screen illustrated in FIG. 3. Hereinafter, link text may simply be referred to as URL.

When a user clicks the link text, the program for downloading starts and identifies the file in accordance with the parameter. In addition, the program displays, on the computer of the user of the destination address of the URL notification mail, a dialog box including an open button B4 for commanding opening of the file, a save button B5 for commanding saving of the file, and a cancel button B6 for cancelling, as illustrated in FIG. 4B. By pressing one of these buttons, the user can open the file and check the content of an image, save the file in their personal computer, or cancel the operation.

In a case where the checkbox C illustrated in FIG. 3 has been unchecked, a dialog box is displayed for a destination address that has been set on the display screen illustrated in FIG. 3. The dialog box includes a yes button B7 for designating deleting of the file on the server, a no button B8 for commanding retaining of the file, as illustrated in FIG. 4C.

Here, if there are two or more destination users, the dialog box illustrated in FIG. 4C is displayed for all users, and the file is deleted when all users have pressed the yes button B7.

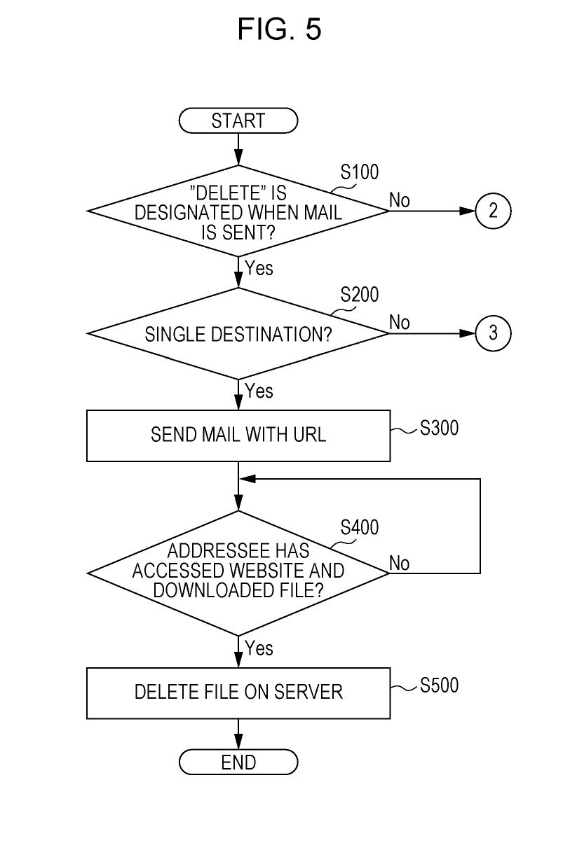

Referring to flowcharts in FIGS. 5 to 8, the operation of the file management method will be described in detail below.

It is determined whether “delete” is designated when a URL notification mail is sent (step S100). When the checkbox C illustrated in FIG. 3 is checked, “delete” is designated. In a case where it is determined that “delete” is designated, it is determined whether there is a single destination (step S200). In a case where it is determined that there is a single destination, a URL notification mail is sent to a set destination address as illustrated in FIG. 4A (step S300).

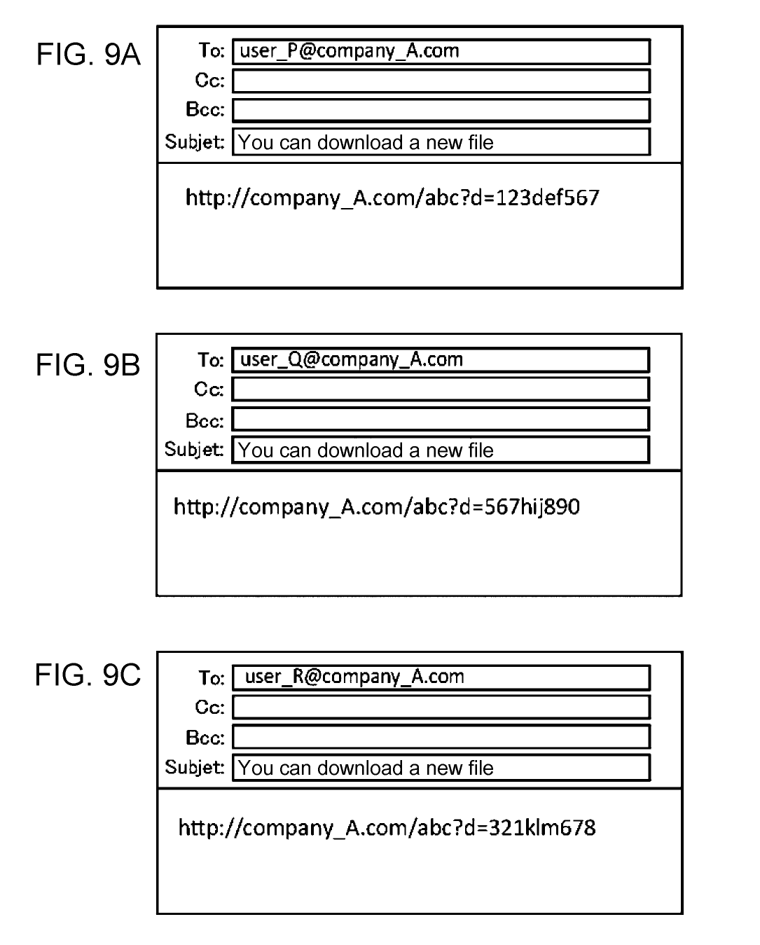

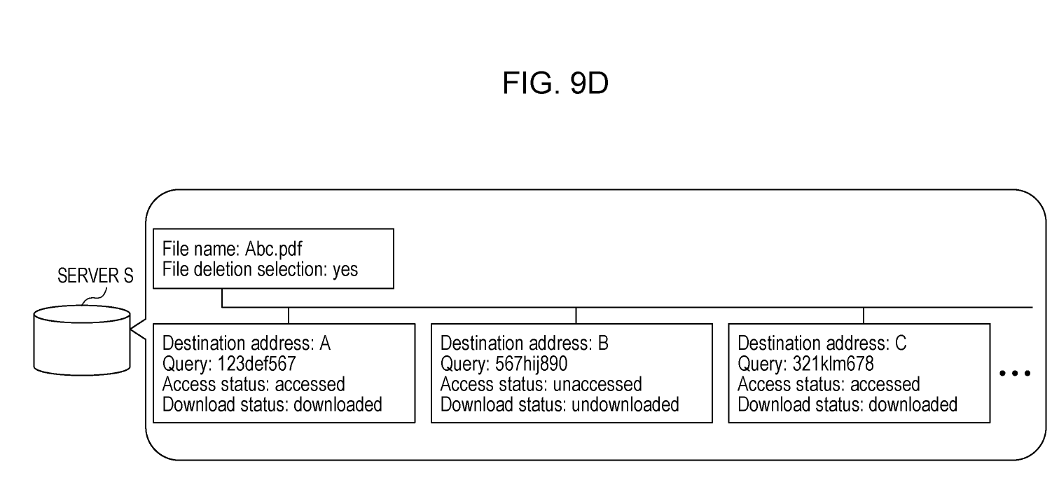

Next, it is determined whether the addressee of the URL notification mail has accessed the URL contained in the email and downloaded the file (step S400). In a case where it is determined that the file has been downloaded, the file on a server S (see FIG. 9D) is deleted (step S500).

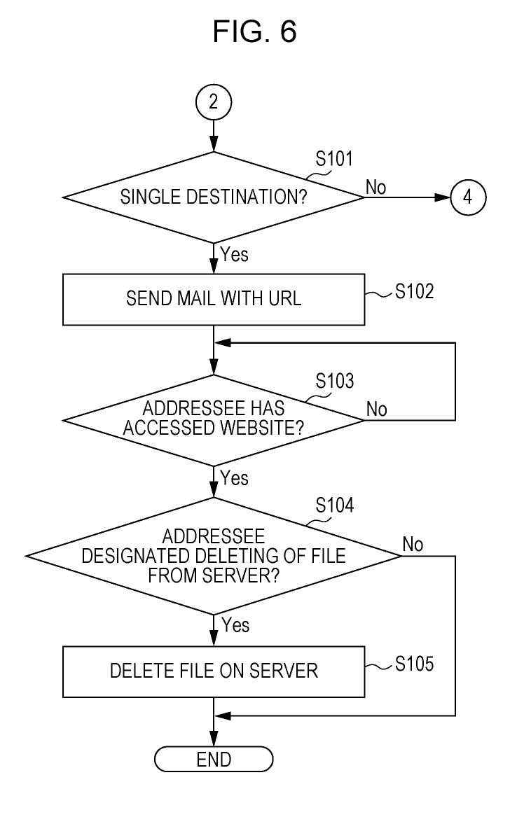

In a case where “delete” is not designated when a URL notification mail is sent, in other words, in a case where the checkbox C illustrated in FIG. 3 is unchecked, it is determined whether there is a single destination (step S101 in FIG. 6). In a case where it is determined that there is a single destination, a URL notification mail is sent to a set destination address as illustrated in FIG. 4A (step S102).

Subsequently, it is determined whether the addressee of the URL notification mail has accessed the URL in the email (step S103). In a case where it is determined that the addressee has accessed the URL, it is determined whether the addressee of the URL notification mail designated deleting of the file from the server S by pressing the “Yes” button B7 on the dialog box illustrated in FIG. 4C (step S104). In a case where it is determined that deleting of the file is designated, the file on the server S is deleted (step S105).

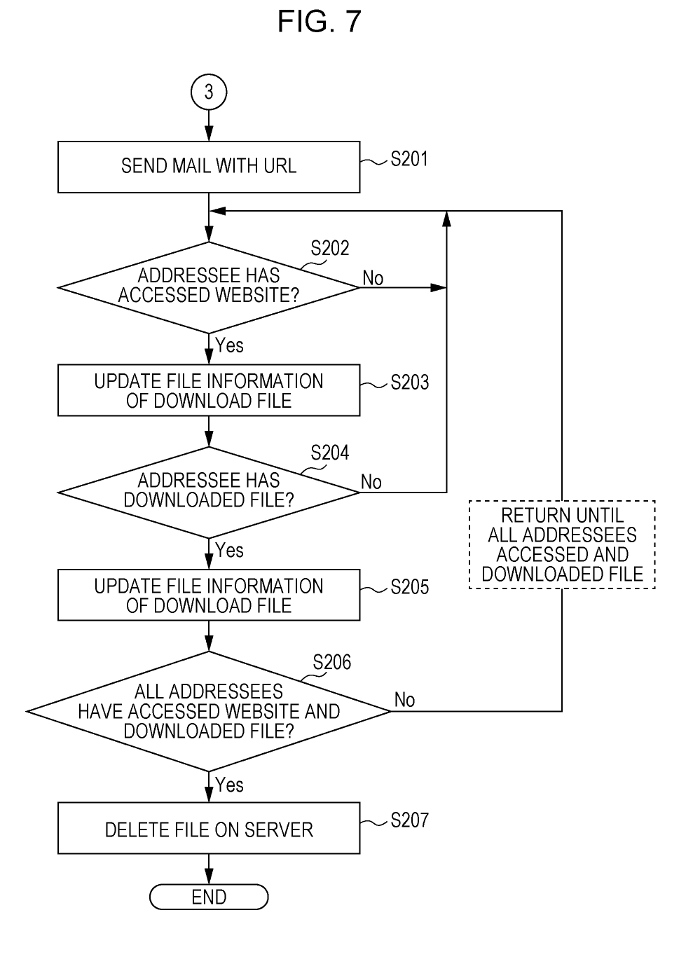

Referring back again to FIG. 5, it is determined whether there is a single destination (step S200). In a case where it is determined that the destination is not only one, that is, there are multiple destinations, a URL notification mail is sent to all set destination addresses (step S201 in FIG. 7).

Here, in a case where there are multiple destinations, URL notification mails that contain link texts each including the URL of the program for downloading and a parameter for specifying an image data file are sent, as illustrated in FIGS. 9A, 9B, and 9C. As illustrated in FIGS. 9A, 9B, and 9C, the URL notification mails are sent to destination address A with “http://company_A.com/abc?d=123def567”, to destination address B with “http://company_A.com/abc?d=567hij890”, and to destination address C with “http://company_A.com/abc?d=321klm678”.

As illustrated in FIG. 9D, in the server S, the file name and the file deletion selection are registered as well as, for each of the destination addresses A, B, and C of the file, a query, an access status, and a download status. In this example, since the checkbox C illustrated in FIG. 3 has been checked, “file deletion selection: yes”, which indicates that deleting of the file on the server S after downloading has been set, is registered.

In this example, for destination address A the query “123def567”, the access status “accessed”, the download status “downloaded”, for destination address B the query “567hij890”, the access status “unaccessed”, the download status “undownloaded”, and for destination address C the query “321klm678”, the access status “accessed”, the download status “downloaded” are registered. A link text including a distinctive parameter for specifying the same image data file is assigned for each addressee, and therefore an addressee who accesses the file can be identified because the addressee accesses the file by clicking the distinctive URL in the URL notification mail.

The description continues with reference back to FIG. 7. It is determined whether the addressee of the URL notification mail has accessed the URL (step S202). In a case where it is determined that the addressee has accessed the URL, the file information of the download file as illustrated in FIG. 9D is updated (step S203). To be specific, “access status: unaccessed” is changed to “access status: accessed”.

Next, it is determined whether the addressee of the URL notification mail has downloaded the file (step S204). In a case where it is determined that the file has been downloaded, the file information of the download file as illustrated in FIG. 9D is updated (step S205). To be specific, “download status: undownloaded” is changed to “download status: downloaded”.

Subsequently, it is determined whether all addressees of the URL notification mail has accessed the URL and downloaded the file (step S206). In a case where it is determined that the file has been downloaded by all addressees, the file on the server S is deleted (step S207).

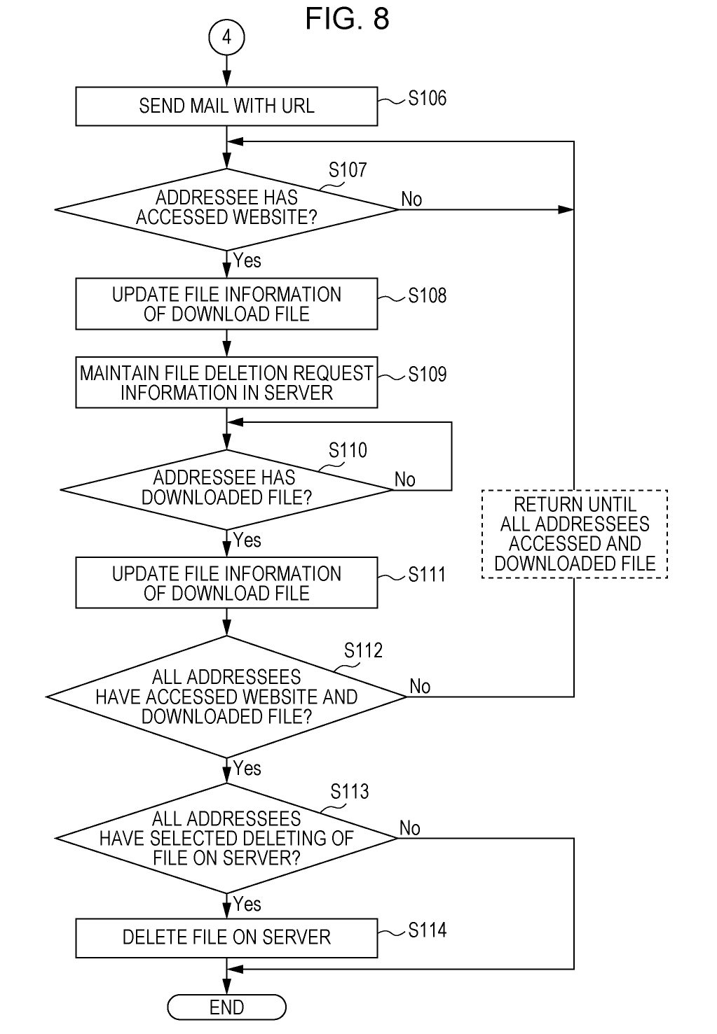

Referring back again to FIG. 6, it is determined whether there is a single destination (step S101). In a case where it is determined that the destination is not only one, URL notification mails that contain link texts each including the URL of the program for downloading and a parameter for specifying an image data file are sent to all set destination addresses (step S106 in FIG. 8).

Here, in a case where there are multiple destinations, URL notification mails that contain link texts each including the URL of the program for downloading and a parameter for specifying an image data file are sent, as illustrated in FIGS. 9A, 9B, and 9C. As illustrated in FIGS. 9A, 9B, and 9C, the URL notification mails are sent to destination address A with “http://company_A.com/abc?d=123def567”, to destination address B with “http://company_A.com/abc?d=567hij890”, and to destination address C with “http://company_A.com/abc?d=321klm678”.

As illustrated in FIG. 9D, in the server S, the file name and the file deletion selection are registered as well as, for each of the destination addresses A, B, and C of the file, a query, an access status, and a download status. In this example, since the checkbox C illustrated in FIG. 3 has been unchecked, “file deletion selection: no”, which indicates that deleting of the file on the server S after downloading has not been set, is registered.

In this example, for destination address A the query “123def567”, the access status “accessed”, the file deletion request “requested”, the download status “downloaded”, for destination address B the query “567hij890”, the access status “unaccessed”, the file deletion request “unrequested”, the download status “undownloaded”, and for destination address C the query “321klm678”, the access status “accessed”, the file deletion request “requested”, the download status “downloaded”, are registered. A website is assigned for each addressee, and therefore an addressee who accesses the file can be identified because the addressee accesses the file by clicking the distinctive URL in the URL notification mail.

The description continues with reference back to FIG. 8. It is determined whether the addressee of the URL notification mail has accessed the website (step S107). In a case where the addressee has accessed the URL, the file information of the download file as illustrated in FIG. 9D is updated (step S108). To be specific, “access status: unaccessed” is changed to “access status: accessed”.

Next, the file deletion request information in the server S is maintained (step S109). More specifically, in a case where “Yes” is selected on the screen in FIG. 4C, the file deletion request information is set to “Yes”, conversely, in a case where “No” is selected on the screen, the file deletion request information is set to “No”.

Next, it is determined whether the addressee of the URL notification mail has downloaded the file (step S110). In a case where it is determined that the file has been downloaded, the file information of the download file as illustrated in FIG. 9D is updated (step S111). To be specific, “download status: undownloaded” is changed to “download status: downloaded”.

Subsequently, it is determined whether all addressees of the URL notification mail has accessed the URL and downloaded the file (step S112).

In a case where it is determined that the file has been downloaded by all addressees, it is determined whether all addressees have selected deleting of the file on the server S (step S113). In a case where it is determined, according to the file deletion request information of all addressees, that all addressees have selected deleting of the file, the file on the server S is deleted (step S114).

As described above, the technique according to the first embodiment may be efficient, easy to use, and capable of minimizing the risk of information leakage by timely deleting a file on a website when the file is no longer desired.

### Second Embodiment

An image data file and a destination address can be identified by a parameter added at the end of the URL in the first embodiment. However, a connected parameter (an image-file-corresponding part and a destination-address-corresponding part) or two parameters may be applied. Furthermore, flags indicating the access status, the download status, and deletion approval/disapproval of the user of each destination address may be embedded in an image data file, and the embedded flags may be read and written.

### Third Embodiment

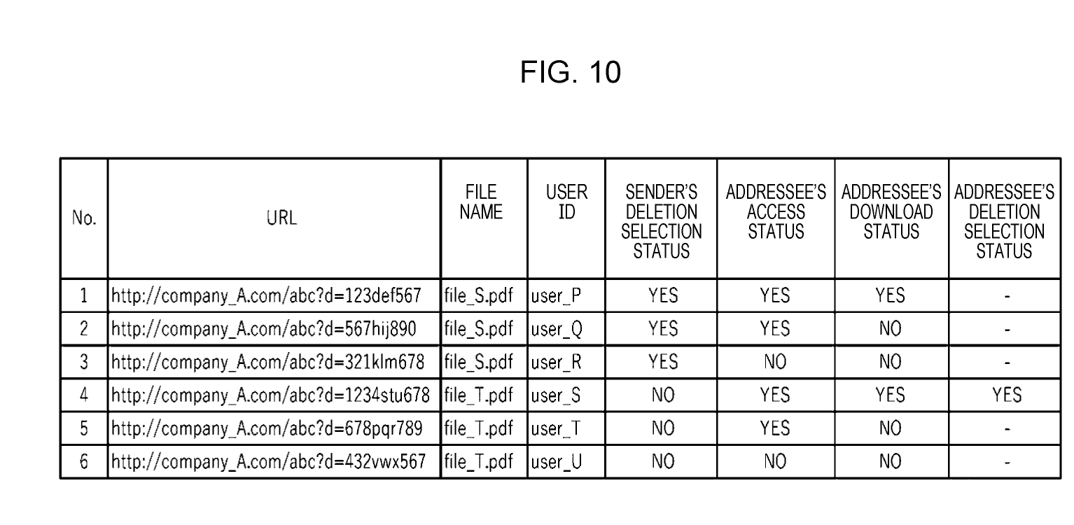

FIG. 10 is a management table that is used in a third embodiment. Referring to FIG. 10, the management table contains fields as follows:
record number
URL
file name
user ID
sender's deletion selection status
addressee's access status
addressee's download status
addressee's deletion selection status.

A URL contains a parameter corresponding to a pair of a file name and a user ID.

Sender's deletion selection status reflects the selection by a sender. Addressee's access status, addressee's download status, and addressee's deletion selection status are for recording the statuses of an addressee.

An addressee by whom an image data file is displayed or downloaded can be identified according to this table.

In a case where sender's deletion selection status for an specific image data file is “YES”, the addressee's deletion selection status for the file is unwritten and the selection status of the addressee is ignored.

In a case where sender's deletion selection status for an specific image data file is “NO”, it is determined, according to the addressee's deletion selection, whether the image data file can be deleted.

According to this table, it can be determined whether a specific image data file has been downloaded by all addressees.

According to this table, it can also be determined whether a specific image data file has been displayed by all addressees.

The management table may keep only the following fields:
record number
URL
file name
user ID
   and the fields including:
sender's deletion selection status
addressee's access status
addressee's download status
addressee's deletion selection status
   may be contained in each image data file or may be contained in another file corresponding to each image data file.

### Fourth Embodiment

An image data file and a destination address can be identified by a parameter added at the end of the URL in the first embodiment. In a fourth embodiment, the same file may be uploaded to different URLs. Accordingly, the different URLs are included in the message bodies of URL notification mails to be sent to different destination addresses. This allows the same image data file to be downloaded by accessing any URL, and it can be determined which destination address of URL notification mail has accessed the file.

### Fifth Embodiment

A case where a file is deleted after all users have downloaded the file is described in the first embodiment. However, if a user has not downloaded an image data file within a time limit, the image data file may be sent with a URL notification mail, thereby deeming that all users has download the file.

### Sixth Embodiment

In the fifth embodiment, in a case where the sender has designated deleting of the file, even if there is a user who has not downloaded the file within a time limit, the file may be deleted.

### Seventh Embodiment

In the fifth embodiment, in a case where the sender has not designated deleting of the file, deleting of the file may be determined according to file deletion selections of all users of destination addresses of a URL notification mail while it is deemed that a user who has not downloaded the file within a time limit have selected deleting of the file.

### Eighth Embodiment

Unlike the fifth embodiment, in a case where a user has not downloaded the image data file within a time limit, the image data file may not be sent to the user.

### Ninth Embodiment

In the eighth embodiment, if the sender has designated deleting of the file, the file may be deleted at the timing of a time limit.

### Tenth Embodiment

In the eighth embodiment, in a case where the sender has not designated deleting of the file, deleting of the file may be determined according to file deletion selections of all users of destination addresses of a URL notification mail while it is deemed that a user who has not downloaded the file within a time limit have selected deleting of the file.

### Eleventh Embodiment

In the fourth to tenth embodiments described above, the deleted file may be moved to a secure location such as a save server with enhanced security. In this case, consuming the storage capacity of the multifunction apparatus for the deleted file may be avoided.

### Twelfth Embodiment

In the eleventh embodiment, a URL notification mail may inform users that the file is saved in another location.

### Thirteenth Embodiment

In the first to twelfth embodiments, a reminder mail saying “The file will be deleted soon, please access the file.” may be sent.

### Fourteenth Embodiment

For an address for a carbon copy (Cc) used together with a destination address for the file, sending of a URL, informing of saving the file in another location, and sending of a reminder mail, which are described in the first to thirteenth embodiments may not be performed. In addition, when a determination is to be made for all users, an address for a Cc may be treated as an outside user with respect to the determination. In other words, an address for a Cc may be excluded from various determinations.

It should be noted that the file management device described above may be implemented by hardware, software, or a combination thereof. Furthermore, the file management method performed by the file management device described above may also be implemented by hardware, software, or a combination thereof. Here, realization by employing software means realization by employing a program that is read and executed by a computer.

The program may be stored and provided to a computer by using any type of non-transitory computer-readable media. Non-transitory computer readable-media include any type of tangible storage media. Examples of non-transitory computer-readable media include magnetic storage media (for example, flexible disks, magnetic tapes, hard disk drives), optical magnetic storage media (for example, magneto-optical disks), Compact Disc Read Only Memory (CD-ROM), CD-R, CD-R/W, and semiconductor memories (for example, mask ROM, Programmable ROM (PROM), Erasable PROM (EPROM), flash ROM, random access memory (RAM)). The program may be provided to a computer by using any type of transitory computer readable media. Examples of transitory computer readable media include electric signals, optical signals, and electromagnetic waves. Transitory computer readable media can provide the program to a computer via a wired communication line, such as electric wires and optical fibers, or a wireless communication line.

The present invention may be embodied in other specific forms without departing from the spirit or the essential attributes thereof, and it is therefore desired that the present embodiments be considered in all respects as illustrative and not restrictive, reference being made to the appended claims, rather than to the foregoing description, and all changes which come within the meaning and range of equivalency of the claims are therefore intended to be embraced therein.

The present disclosure can be employed to perform appropriate deletion processing and enhance security for uploaded files on a server.

The present disclosure contains subject matter related to that disclosed in Japanese Priority Patent Application JP 2017-112758 filed in the Japan Patent Office on Jun. 7, 2017, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A file management device, comprising:
a file recording unit that records a file in a given area of a storage medium;
a download information transmission unit that transmits download information for downloading the file from the storage medium to one, two, or more download-destination users designated by a transmitting user;
a download unit that causes the one, two, or more download-destination users who request downloading of the file in accordance with the download information to download the file; and
a file deletion unit that deletes the file upon completion of downloading the file in a case of deletion designation performed by an authorized user.

2. The file management device according to claim 1, further comprising:
a file deletion suspension unit that suspends file deletion to be performed by the file deletion unit until downloading the file by each of the one, two, or more download-destination users designated by the transmitting user is detected.

3. The file management device according to claim 2, wherein
in a case where the two or more download-destination users are present, the download information transmission unit provides different download information for an identical file for each of the two or more download-destination users, and
the file deletion suspension unit detects whether each of the two or more download-destination users designated by the transmitting user has downloaded the file in accordance with the different download information.

4. The file management device according to claim 2, wherein
even if downloading the file by each of the one, or two or more download-destination users designated by the transmitting user is not detected, in a case where a predetermined deemed-all-users condition is satisfied, the file deletion suspension unit deems that each of the one, two, or more download-destination users designated by the transmitting user has downloaded the file.

5. The file management device according to claim 4, further comprising:
a file transmission unit that transmits, in accordance with a predetermined transmission condition, the file to a download-destination user, downloading the file by the download-destination user having not been detected, wherein
the deemed-all-users condition is that the file transmission unit has transmitted the file to the download-destination user, downloading the file by the download-destination user having not been detected.

6. The file management device according to claim 1, wherein
the authorized user is a registrant who causes the file recording unit to record the file in the given area of the storage medium, the transmitting user, or any of the one, two, or more download-destination users.

7. The file management device according to claim 6, wherein
the file deletion unit includes a first designation reception unit that receives, from the registrant or the transmitting user, designation of whether to delete the file upon completion of downloading the file, and
in a case where the first designation reception unit receives designation of deleting the file, the file deletion unit deletes the file upon completion of downloading the file.

8. The file management device according to claim 6, wherein
the file deletion unit includes a second designation reception unit that receives, from any of the one, two, or more download-destination users, designation of whether to delete the file upon completion of downloading the file, and
in a case where the second designation reception unit receives designation of deleting the file, the file deletion unit deletes the file upon completion of downloading the file.

9. A multifunction apparatus comprising the file management device according to claim 1.

10. A file management method comprising:
recording a file in a given area of a storage medium;
transmitting download information for downloading the file from the storage medium to one, two, or more download-destination users designated by a transmitting user;
causing the one, two, or more download-destination users who request downloading of the file in accordance with the download information to download the file; and
deleting the file upon completion of downloading the file in a case of deletion designation performed by an authorized user.

11. A non-transitory computer-readable medium storing a program causing a computer to function as the file management device according to claim 1.
